(19) United States
(12) Patent Application Publication
(10) Pub. No.: US 2017/0240269 A1
(43) Pub. Date: Aug. 24, 2017

(54) Method for Improving Aircraft Engine Operating Efficiency

(71) Applicant: Borealis Technical Limited, North Plains, OR (US)

(72) Inventor: Isaiah W. Cox, London (GB)

(21) Appl. No.: 15/441,555

(22) Filed: Feb. 24, 2017

Related U.S. Application Data
(60) Provisional application No. 62/299,475, filed on Feb. 24, 2016.

(51) Int. Cl. B64C 19/02; B64D 31/00; B64D 41/00; B64C 25/40

(52) U.S. Cl. CPC B64C 19/02; B64C 25/405; B64D 31/00; B64D 41/00

(57) ABSTRACT

A method is provided for improving aircraft engine operating efficiency during flight in aircraft driven on the ground by electric taxi systems that extends engine warm up and cool down time during ground operations without increasing the time an aircraft spends on the ground. Aircraft are driven by electric taxi systems between landing and take off with the main engines simultaneously maintained at throttle setting for time periods that ensure even and symmetrical heating or cooling for all engine components. When the aircraft reaches a location where idle or take off thrust is required before take off, engine thrust may be increased without the adverse effects of differential thermal expansion of engine components during flight. Aircraft engines may be designed to rely on electric taxi operation and extended warm up and cool down times without delaying push back or taxi-in or otherwise negatively impacting airport operations.

### PRIORITY CLAIM

This application claims priority from U.S. Provisional Patent Application No. 62/299,475, filed 24 Feb. 2016, the disclosure of which is hereby fully incorporated herein by reference.

### TECHNICAL FIELD

The present invention relates generally to producing improvements in operating efficiency and performance of aircraft engines and specifically to a method for improving the operating efficiency and performance of aircraft engines in aircraft equipped with electric taxi systems for autonomous ground movement.

### BACKGROUND OF THE INVENTION

Increasing aircraft engine operating efficiency and performance has many benefits. When aircraft engines operate with optimum efficiency during flight, not only is fuel saved, but engine life may also be extended. The frequency of required engine repairs and the cost of engine maintenance may also be reduced. A primary cause of engine damage that interferes with engine operating efficiency is associated with a reduction in the time available for warming up and cooling down the aircraft's engines when an aircraft is on the ground prior to takeoff and after landing. At busy airports in particular, airlines and/or airport operators try to keep aircraft on the ground for as little time as possible between landing and departure. The result of such pressures may leave less time for aircraft engine warm up and cool down than is desirable for long term engine operating efficiency.

Most commercial passenger aircraft are powered by two or more jet turbine engines with rotor blades mounted on a hub or shaft to rotate within a shroud or like housing structure that may have a static seal. A clearance between the tips of the turbine blades as they rotate within the shroud during engine operation must be maintained to avoid contact between the blade tips and the shroud or static seal. Engine performance parameters, including, for example, thrust, specific fuel consumption, and exhaust gas temperature margin, are dependent on the relationship between blade tips and shrouds or static seals circumferentially surrounding the blade tips. It is important to minimize blade tip clearance while avoiding rubs or other contact between the blade tips and the adjacent shroud or static seal. However, minimizing this clearance presents challenges. During engine operation, the turbine blade tip length from the hub or from an engine axis may increase or decrease at a different rate than the shroud can expand or contract to accommodate the changes in blade tip length. As a result, there may be insufficient blade tip clearance, and the blade tip may contact or rub the shroud or static seal, or there may be excess clearance. In the first instance, rotation of the turbine rotor may be adversely affected and the blade tip and/or shroud or static seal may be damaged, reducing the lives of these engine components. In the second instance, poor engine performance may result.

The clearance gap between the turbine blade tip, which may be referred to as the turbine tip seal gap, may have a dimension that is comparable to the width of a human hair. This clearance gap, which normally varies throughout an aircraft's flight, minimizes airflow losses and cools the turbine blades and shroud or engine casing and sealing structures when maintained at an optimum width. Tip clearance loss may account for a significant amount of engine airflow loss, potentially in the range of about 20% to 40%, depending on the engine type. When an optimum tight tip clearance gap is not maintained, the leakage airflow may induce unsteady heat loads onto the engine rotor casing, resulting in significant thermal stresses at the turbine blade tip.

Clearances between turbine blade tips and the shrouds or housings in which they rotate are affected by differences in the amounts and rates of thermal and mechanical expansion during engine operation. Mechanical expansion or growth is due to centrifugal force that occurs with changing speeds and pressures, with mechanical growth of the turbine blades and engine rotor being greater than that of the engine stator, which experiences greater thermal growth than the blades or rotor. Thermal growth of the turbine blades occurs more quickly than the thermal growth of either the engine stator or the rotor. Ideally, these different growths or expansions of the turbine blades and other engine components should be matched and as tight a clearance as possible maintained between the blade tips and shroud during engine operation.

It has been determined that the length of the turbine blade from the hub to the tip grows in proportion to the square of the rotor angular velocity and linearly with temperature. These results occur when fuel flow is increased, for example, as an aircraft climbs, during portions of its descent and landing sequence, or when the aircraft takes evasive action during flight. Active clearance control may be employed to maintain an optimum clearance between blade tips and the shroud during engine operation. Such processes may involve, for example, bathing the shroud in hot or cold air to cause the shroud to expand or contract as required to match thermal growth or contraction of the turbine blades during engine operation in flight. Control software has been developed to electronically monitor and control blade tip clearance, altering the gap between the blade tip and shroud as required to maintain an optimum clearance during engine operation. For example, U.S. Pat. No. 8,126,628 to Hershey et al. describes an example of an active clearance control system that electronically monitors blade tip clearance during flight and automatically adjusts tip clearance at an appropriate time before an engine command that changes the engine's rotational speed.

As noted, the time pressures exerted by airlines and airport operators to keep aircraft moving into and out of gates and taking off after a relatively short engine warm up time may result in adverse effects on engine operation in flight. An observed adverse effect that may affect all aircraft engines, and particularly affects models of engines that require a longer warm up time, is known as rotor bow. This condition results from the differential thermal and mechanical expansion of the blades and rotors discussed above and causes the blade tips to rub against the shroud or casing walls because thermal bowing of the rotor has occurred. Rotor bow, or thermal bowing, may occur as a result of asymmetrical cooling after shut down of an engine on the previous flight. Differential thermal deformation of the material of the engine shaft section supporting the rotors as a result of temperature differences across the shaft causes the rotor axis to bend. The result may be an offset in the center of gravity of the bowed rotor and the clearance between the blade tips and the compressor or shroud wall. It has been recognized that all engines may display some degree of rotor bow. As discussed above, maintaining blade tip clearance as closely as possible to an optimal minimum clearance may have a critical impact on engine operating efficiency. When an aircraft engine is thoroughly warmed up prior to take off and slowly cooled down after landing, the rotor, shaft, and other engine components may be heated and cooled evenly so that differential thermal and mechanical expansion may be controlled and rotor bow is minimized and, ideally, eliminated.

There is clearly a tension in current airport and airline operations between moving aircraft as quickly as possible between landing and take off to minimize time aircraft spend on the ground so that airport use and aircraft flight cycles are maximized and providing adequate time for aircraft engines to be warmed up prior to take off and cooled down after landing to maximize engine operating efficiency during flight. The art has not provided a solution to this dilemma.

### SUMMARY OF THE INVENTION

It is primary object of the present invention, therefore, to provide a method for extending aircraft time on the ground to warm up and cool down engines more slowly than is presently available without increasing aircraft time on the ground or negatively impacting airport ground operations.

It is another object of the present invention to provide a method for maximizing engine operating efficiency during flight by providing sufficient time to warm up and cool down aircraft engines so that differential thermal and mechanical expansion of engine components is controlled.

It is an additional object of the present invention to provide a method for extending aircraft engine run times before requiring idle thrust or take off thrust without increasing aircraft time on the ground between landing and take off.

It is a further object of the present invention to provide a method for extending aircraft engine run times prior to take off and after landing that enables engines to be designed for and operated for longer warm up and cool down times than are currently possible without adversely affecting airport operations.

It is a further object of the present invention to provide a method for the slow steady cool down of aircraft engines after landing that controls thermal properties of engine components while the aircraft is driven on the ground.

It is yet another object of the present invention to provide a method for minimizing or avoiding rotor bow in aircraft engines that are cooling down after landing that cools rotors with air supplied by an aircraft air source.

It is yet another object of the present invention to provide a method for providing adequate time for controlled aircraft engine cool down and warm up after landing and prior to take off without extending time required at a gate or for ramp operations.

It is yet a further object of the present invention to provide a method for moving an aircraft during ground travel that allows adequate time for controlled aircraft engine cool down and warm up after landing and prior to take off implemented in an aircraft powered for ground movement by an electric taxi system.

In accordance with the foregoing objects, a method for increasing aircraft engine operating efficiency based on increasing engine warm up time while an aircraft is on the ground that does not increase the time an aircraft spends on the ground between landing and take off is provided. The present method employs aircraft equipped with pilot-controllable electric taxi systems to drive aircraft during ground travel without operation of aircraft main engines or external tow vehicles. The aircraft equipped with the electric taxi systems are driven only with the electric taxi systems, with both the electric taxi systems and the aircraft engines, or only with the aircraft engines at different times during aircraft ground travel after landing and prior to takeoff to ensure sufficient time for optimum aircraft engine warm up and cool down while the aircraft is kept moving on the ground.

After landing, the aircraft engines continue to operate at reduced thrust when the electric taxi systems are activated and controlled to drive the aircraft for a time or a distance that permits the engines to cool down. Aircraft may be driven by the electric taxi systems after landing to a terminal parking location while both engines are operating at a very low throttle setting selected to promote optimal cooling of the engines. When the engines are sufficiently cooled down, they are turned off, and the aircraft is driven only with the electric taxi systems to an airport parking location. Alternatively, the aircraft engines may be kept turning over slowly at a no throttle setting or while they are not operating and cooled with air supplied to the engine rotors from a source of air on the aircraft.

When the electric taxi systems-equipped aircraft are cleared for departure, the electric taxi systems are activated and controlled to drive the aircraft forward and/or reverse as required to push back from the parking location to an engine warm up location where the engines may be safely started without the risks posed by jet blast or engine ingestion. The aircraft is driven with the engines maintained in a low throttle condition, typically below idle thrust, and also with the electric taxi systems to an engine thrust location, typically on a takeoff runway, where the engines may require an idle thrust or a higher takeoff thrust. The electric taxi systems are inactivated at the engine thrust location, and the aircraft are then driven only with the engines to take off. The distance between the engine warm up location and the engine thrust location is selected to provide sufficient time for the engines to warm up and all for engine components to be heated evenly. When the aircraft driven by both the electric taxi systems and the engines at low thrust reaches the engine thrust location, an extended period of controlled warm up will have occurred before higher engine thrust is required, and the engine and engine components will be in an optimal thermal state without disturbing the controlled warm-up process.

The present method enables aircraft engines to be designed with longer warm up and cool down times than are presently required without delaying push back, taxi-in, and ground servicing, increasing the time aircraft spend on the ground, or otherwise adversely affecting airport operations.

### BRIEF DESCRIPTION OF THE DRAWINGS

FIG. 1 is a schematic view of a portion of an aircraft engine illustrating clearance between turbine blade tips and an adjacent shroud or casing that may or may not have a static seal or other seal element;

FIG. 2 is a diagrammatic view of an aircraft equipped with the engine of FIG. 1 and an electric taxi system mounted in the nose landing gear wheels of the aircraft; and

FIG. 3 is a diagram of ground travel of an aircraft controlled by an electric taxi system moving from a terminal parking location through push back to a location where engine warm up begins to the commencement of idle or take of thrust and then aircraft take off according to the method of the present invention.

### DESCRIPTION OF THE INVENTION

As discussed above, current airport ground operating procedures and the pressures resulting from minimizing aircraft time on the ground between landing and take off may not provide an optimum, or even a sufficient, amount of time to adequately warm up aircraft engines. An adequate engine warm up time prevents damage to engine components, for example rotor bowing where distorted rotors cannot maintain optimum rotor blade tip clearance during flight. Engine operating efficiency may be reduced when aircraft engine components are damaged or distorted as a result of an improperly warmed up or cooled down engine. Aircraft engine designers must presently design and configure aircraft engines to conform to engine start times imposed by airport operators. At most airports, the time between when an aircraft engine is started prior to take off and the subsequent application of idle thrust or take off thrust is currently about 150 seconds, although engine start times may be shorter. While shorter engine start times may reduce aircraft time on the ground, this may be achieved at a cost in the form of uneven heating and differential thermal expansion of aircraft engine components.

When an aircraft engine is heated unevenly, one result of the differential thermal expansion of the rotor blade is rotor bowing and adverse contact between the blade tip and the engine casing or shroud. In addition, the optimum clearance gap between the blade tips and the casing or shroud that promotes airflow and enhances engine operating efficiency cannot be maintained. Consequently, engine performance suffers during flight and engine components, particularly rotors, casings, and seals, may need increased maintenance and frequent replacement. Providing sufficient time for an engine to warm up and cool down in a manner that minimizes differential thermal expansion before starting the engine would both improve engine operating efficiency during flight and reduce engine maintenance and repair requirements.

When engines can be kept running on low throttle or thrust settings, or on no thrust settings or off, while aircraft are being moved to a terminal parking location after landing, engine cool down occurs more evenly so that rotor bow and other thermally-induced structural deformations may be avoided. The even cooling of aircraft engines that have been turned completely off after landing may be accomplished with cooling air from a source of air on the aircraft directed at the engine rotors to keep the rotors turning while the engines are off. Rotor bow may be avoided by keeping the rotors turning over slowly, even very slowly, while the rotors are cooled with airflow directed at them while they turn. One source of cooling air useful for this purpose may be bleed air from the aircraft's auxiliary power unit (APU). Other aircraft air sources may also be employed to provide cooling air, or a dedicated engine cooling air source may be provided.

Moving aircraft on the ground without thrust from main engines by using electric taxi systems has been proposed. Such systems employ electric motors that may be mounted to drive aircraft landing gear wheels during taxi and move the aircraft on the ground between landing and take off without operation of the aircraft's main engines, or autonomously. Typically, after an aircraft equipped with one or more electric taxi systems lands, the aircraft engines are shut down as soon as possible, the electric taxi systems are activated and controlled, and the aircraft is driven to a terminal gate or parking location only with the electric taxi systems. When the aircraft is cleared for departure, the electric taxi systems are activated and controlled to push back the aircraft, without external tow vehicles or operating engines, and the aircraft is driven with only the electric taxi systems to a take off location. The current state of the art is to start the aircraft main engines as late as possible before take off. When an aircraft is equipped with an electric taxi system, the art demonstrates that the goal is to shorten aircraft engine run times, primarily to avoid the adverse effects of jet blast and engine ingestion, as well as to minimize damage to engines from foreign object debris (FOD). Other benefits of shortened engine run time may be reductions in fuel use, noise and atmospheric pollution. However, when the running time of aircraft engines is shortened as described, especially the running time of the types of engines that may require longer warm up and/or cool down times, the likelihood of uneven heating of engine components and the differential thermal expansion of those components described above is guaranteed, as are the resulting deviations from the required optimal blade tip clearance.

The method of the present invention is most effectively performed using aircraft equipped with electric taxi systems, such as, for example, the electric taxi systems developed by the present inventor. Such systems are identified by the name WHEELTUG® and are described, for example, in commonly owned U.S. Pat. Nos. 7,975,960; 9,022,316; and 9,033,273 and in U.S. Patent Application Publication No. 2013/0062466, among others. The disclosures of the foregoing patents and published patent applications are fully incorporated herein by reference. The present method may also be used by aircraft equipped with other electric taxi systems known in the art. These electric taxi systems may move aircraft efficiently during ground travel and operations and provide significant turnaround time savings compared to aircraft moved during ground travel only with aircraft engines. The present method incorporates the significant time savings possible when aircraft are driven on the ground with electric taxi systems with simultaneously providing sufficient time for aircraft engines, especially those with longer than average warm up and cool down time requirements, to warm up and cool down in a manner that prevents engine damage from adverse thermal stresses.

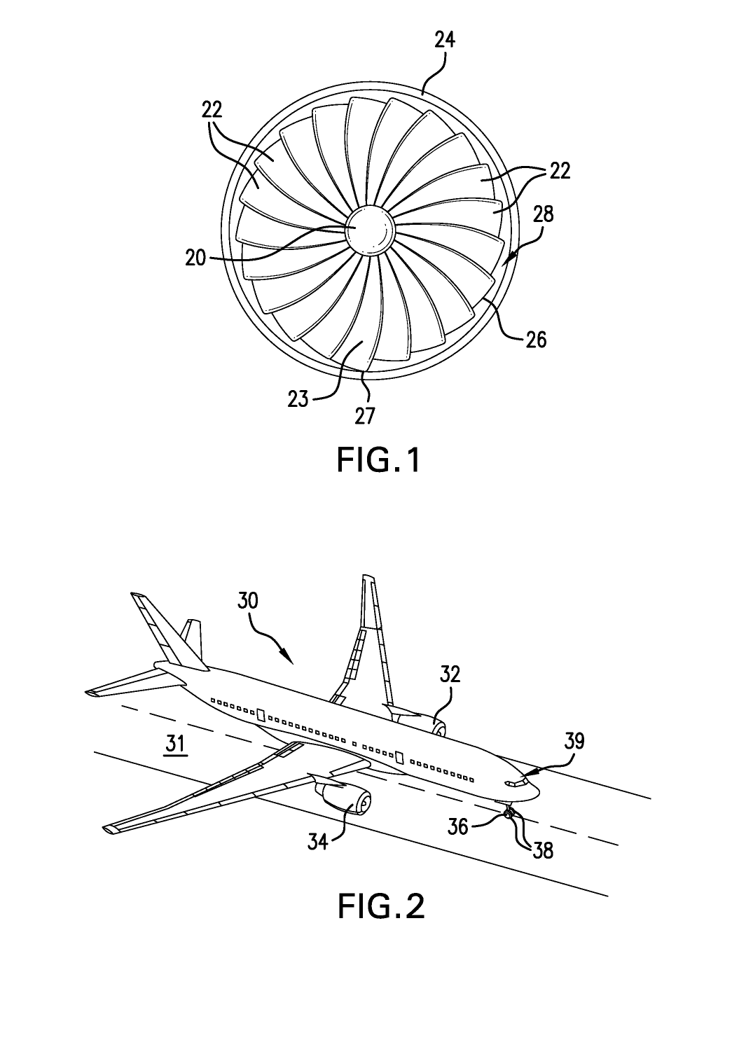

Referring to the drawings, which are not drawn to scale, FIG. 1 is a schematic diagram of a portion of an aircraft engine showing a central hub 20 supporting a number of circumferentially mounted rotors or turbine blades 22 mounted for rotational movement during engine operation within a casing or shroud 24. Each blade 22 has a tip 26 that should be spaced inwardly of the casing or shroud 24 to maintain a clearance gap 28 between the blade tip 26 and the casing 24. As noted above, a tight clearance gap 28, which may be as small as in the range of the width of a human hair, is maintained between the blade tip and the casing. Clearance gaps may be expressed as a percentage of the blade length, such as less than 0.5% of the blade length for a tight clearance and 0.1% and 0.2% of the blade length for very tight clearances. The optimum clearance gap may vary for different manufacturers' engines. One of the rotor blades 23 shown in FIG. 1 exhibits rotor bow, as discussed above, and the tip 27 of blade 23 is shown directly contacting the casing or shroud 24 and will rub against the interior of the casing as the rotor 23 rotates on the hub 20 during engine operation.

FIG. 2 is a schematic drawing of an aircraft 30 equipped with an electric taxi system for use in the present method as it is driven on a runway or taxiway 31 following push back or during taxi-in. The aircraft 30 is shown with two jet engines 32 and 34, one mounted on each wing. Other aircraft may have additional numbers of engines. Each of the engines will include the blades 22 in a casing or shroud 24 as shown in FIG. 1 that will require an optimum clearance gap 28 to be maintained during engine operation to ensure optimum airflow for efficient engine operation. The aircraft may additionally have one or more electric taxi systems 36, such as those referred to in the above-listed patents and published patent application, that include electric drive motors mounted within one or more nose or main landing gear wheels. The electric drive motors may be activated and controlled to move the nose or main landing gear wheels in which they are mounted at a desired speed or torque and, therefore, to drive the aircraft on the ground without operation of the main engines or external tow vehicles. In FIG. 2, two electric taxi systems 36 are mounted within each of the two nose landing gear wheels 38. The main landing gear wheels are not visible; however, one or more electric taxi systems could also be operationally mounted within one or more of the main landing gear wheels to drive the main landing gear wheels. The electric taxi systems 36 may include dedicated pilot controls (not shown) in the cockpit 39 connected to activate and drive the drive motors. Power for the electric drive motors may be supplied by a suitable source of electric power that may include the aircraft auxiliary power unit, as well as other usable sources of electric power that can be located on the aircraft. The electric taxi system 36 is controlled by the pilot and/or cockpit crew to drive the aircraft on the ground without thrust from the aircraft's main engines between landing and take off and at other times when it is necessary to move the aircraft 30 on the ground.

The use of electric taxi systems, such as the landing gear wheel-mounted electric taxi system 36, to drive aircraft during ground operations has heretofore been suggested to reduce aircraft fuel use and to reduce the time aircraft engines may be required to operate during aircraft ground travel. One of the significant benefits of employing an electric taxi system to move aircraft during ground travel is the time savings that are possible. Moving an aircraft on the ground, particularly into and out of a congested airport ramp area, may be done more quickly, efficiently, and safely with an electric taxi system than with thrust from aircraft engines. In addition, since external tow vehicles are not required to move electric taxi system-driven aircraft during push back or at other times, the time required to attach and detach a tow vehicle can be eliminated from the time these aircraft spend on the ground between landing and take off. Reducing the time aircraft spend on the ground may amount to significant cost savings for airlines. Reducing aircraft engine operating time is more likely to increase airlines' costs.

The present method enables airlines to simultaneously realize the benefits of moving an aircraft with an electric taxi system and of extending the available warm up and cool down time for the aircraft's engines. The time when aircraft engines are running during ground operations is actually extended with the present method, rather than shortened as with typically proposed electric taxi systems, so that time is available for the engines to warm up and cool down more slowly and evenly than when engine start times are shortened.

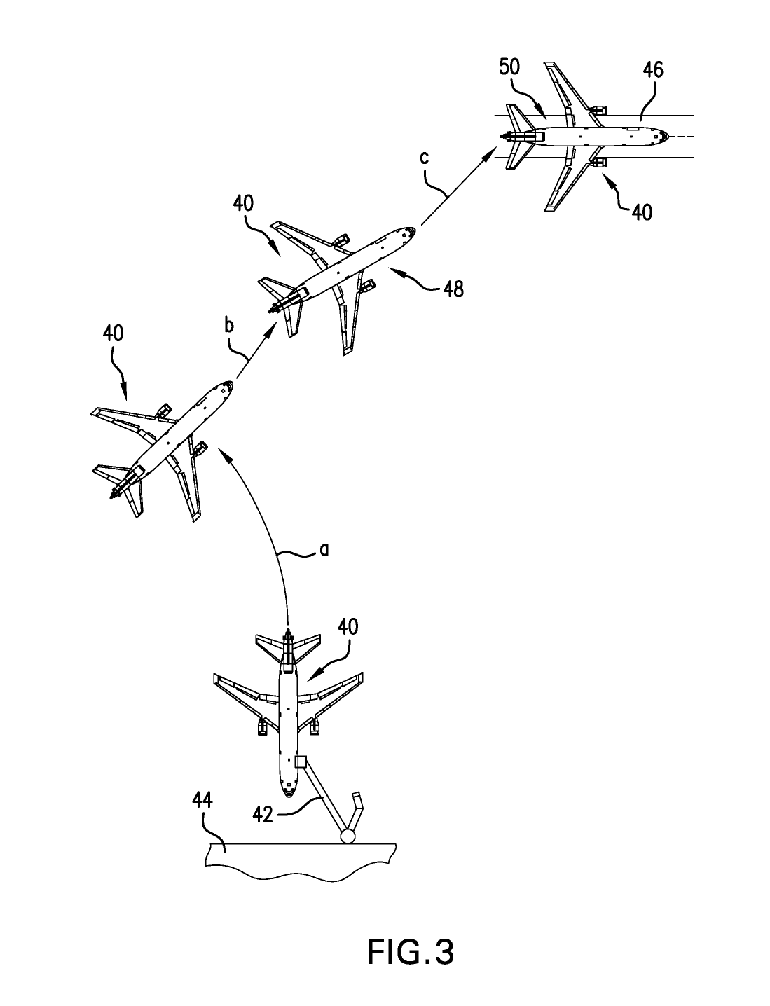

FIG. 3 is a diagram, not drawn to scale, that presents a representation of steps of the present method during push back that enable aircraft to take advantage of the time-saving benefits of ground movement controlled by an electric taxi system while simultaneously providing sufficient time for engine warm up and cool down in a manner that controls differential thermal expansion of rotor blades and other engine components. An aircraft 40 is shown following a path from a parking location 42 at an airport terminal 44 to an assigned take off runway 46. When the aircraft 40 is cleared for departure and push back, the aircraft pilot activates and controls the aircraft's one or more electric taxi systems 36 (FIG. 2) to drive the aircraft in a reverse direction away from the terminal 44, as shown by the arrow a. The aircraft 40 is turned by the electric taxi systems 36 to drive in a forward direction, represented by the arrow b. The aircraft pilot controls the electric taxi systems 36 to drive the aircraft 40 forward toward the assigned take off runway 46, along the general path represented by the arrow b, until the aircraft 40 reaches an engine warm up location 48 along a runway or taxiway on the route to an engine thrust location 50 on an assigned take off runway 46 where it is safe to turn on the main engines at a low or very low throttle or thrust setting to begin warming up the engines.

The distance between the engine warm up location 48 and the engine thrust location 50, represented by arrow c, will vary for different aircraft engine designs and different engine warm up requirements. The risk of damage from FOD at the determined engine warm up location 48 is likely to be minimal, since vortices are not produced at low throttle settings. Further, the other potential adverse effects of engine operation, including jet blast and engine ingestion, are also not likely to pose risks at this location. The aircraft 40 is driven by the pilot-controlled electric taxi system from the engine warm up location 48 along the path represented by arrow c with the engines set at low throttle settings to the engine thrust location 50 on the assigned take off runway 46, where the engines may be set to idle thrust or take off thrust, as required prior to take off. The distance between the engine warm up location 48 and the engine thrust location 50, represented by the arrow c, may be determined by the time required to warm up the aircraft 40's engines sufficiently to ensure steady, even warming prior to changing the low throttle setting to idle thrust or take off thrust. This time may vary for different aircraft engine designs, and the distance between engine warm up location 48 and engine thrust location 50 will also vary accordingly.

When the aircraft 40 takes off from the assigned take off runway 46, the engine should be evenly warmed up without differential thermal or mechanical expansion of rotor blades, blade tips, and other engine components. As a result, rotor bow and blade tip rubs due to differential thermal expansion of these structures, as shown and described in connection with FIG. 1, should not occur, and desired optimum blade tip clearances may be more easily maintained. When the engines have been warmed up as described, the aircraft should take off with the blade tips at or near an optimum clearance required for efficient engine operation. After the aircraft takes off, blade tip clearance may be automatically monitored during flight to maintain the optimum clearance gap for the aircraft's specific engines using methods known in the art.

The present method may also be employed to ensure that aircraft engines are evenly cooled down after landing during taxi-in. Engines may remain on at a very low throttle setting, below idle thrust concurrently while the pilot controls the electric taxi system and drives the aircraft to a terminal parking location, such as parking location 42 (FIG. 3). Current landing procedures for aircraft with two engines, such as engines 32 and 34 (FIG. 1), may shut down one engine after landing, and the other engine may be shut down when the aircraft reaches a gate or other parking location. With the present method, aircraft no longer have to rely on the engines for motive power since the electric taxi system drives the aircraft. Consequently, while the aircraft is being driven by the electric taxi system, both engines may continue to run, albeit at very low throttle settings, until the aircraft reaches its arrival destination or until optimum engine cooling has been achieved. A throttle setting that is ideal or optimal for engine cooling may be determined and maintained while the aircraft taxis in. This ensures that a more predictable cooling and engine shut down routine may be implemented for the taxi-in procedure. Engine hardware and software may be adapted to function specifically for thrust operations with fewer compromises required for start up and shut down sequences.

Alternatively, as noted above, the aircraft engines may be set to a no throttle setting and turned off completely, and engine rotors and/or other rotating components may be rotated by directing a flow of cooling air at these structures to keep them rotating while the electric taxi system is driving the aircraft after landing during taxi-in. For example, bleed air from the APU aimed at rotating engine components can keep these components rotating so that they keep turning, even at a very slow rate, while cooling.

While the method described may require more fuel than shutting down the engines entirely when using only an electric taxi system to drive the aircraft during ground travel, it allows the airline to balance additional fuel consumption costs against engine maintenance costs. Further, the present method produces a reduction in overall fuel requirements, since the throttle settings below idle thrust used in conjunction with operation of the electric taxi system consume less fuel than when only one or more of the engines are propelling the aircraft. Engines given maximum time to warm up prior to being set at idle thrust or take off thrust and to cool prior to being shut down completely operate with greater efficiency and produce corresponding maintenance savings. As discussed above, when thermal expansion of engine components occurs evenly, thermal and mechanical expansion can be matched, and an optimum clearance gap can be maintained between blade tips and the casing or shroud while the engine is operating during flight. Rotor bow can be eliminated, or at least significantly minimized.

With the present method of providing longer than currently available engine warm up and cool down times without increasing aircraft ground time, aircraft engines can be designed specifically to rely on electric taxi systems so that they functional may optimally with these longer warm up and cool down times. Engines may be designed to require the longer warm up times possible with the present method, so that warm up times on the order of minutes longer than the 150 second warm up time typically provided may be implemented. Engine cool down times may also be extended to ensure a cooling time period that produces optimal cooling of engine components. Both of these outcomes may be achieved, moreover, without negatively impacting airport or airline operations. It is anticipated that the improvements in engine operating efficiency and maintenance reduction possible with the present method will extend beyond the rotors and casing or shroud to rotor hubs and other related engine components.

It is additionally anticipated that aspects of the present method may be controlled automatically. For example, the determination of when to begin the engine warm up may be made using data that includes engine type, optimum blade tip clearance gap, engine warm up time requirements, the distance between a terminal parking location and an assigned take off location, engine cool down requirements, the distance between a touchdown location and the terminal parking location, the ground speed of the aircraft driven by the electric taxi system, the travel route to or from the take off or touchdown location, and the like. Other aspects of the method may also be automated using appropriate data. Further, engine operating software may be modified to incorporate the longer warm up and cool down periods possible with the present method.

FIG. 3 shows a standard push back process in which an aircraft is driven in reverse from a nose-in orientation out of a terminal gate or parking location and turns, typically in the outer ramp area, to drive in a forward direction. Electric taxi systems may also be used to drive aircraft into and out of a terminal parking location in only a forward direction and to park either parallel to the terminal or at an optimum parking angle relative to the terminal to permit the simultaneous attachment of passenger loading bridges at gates to both forward and rear aircraft doors. The present method may be used with any of the foregoing aircraft parking arrangements to move an aircraft in either or both a forward and a reverse direction out of the airport ramp area to a safe location, such as engine warm up location 48 in FIG. 3, where the engine may be turned on to a low throttle setting that permits the engine to warm up evenly while the aircraft continues to be driven by the electric taxi system to an engine thrust location, such as location 50 in FIG. 3, where the engine thrust may be increased to idle thrust or take off thrust prior to take off.

With the present method, aircraft engine designers may design engines specifically to rely on the capability provided to extend both warm up and cool down time when an aircraft are equipped with one or more pilot controllable electric taxi systems 36 for ground movement. Engine design and use may rely on the engine's integration with a concurrently functioning electric taxi system to move an aircraft while the engine is running, but at a specifically designed low or very low throttle or thrust setting that facilitates the even, steady application or removal of heat from engine components. An engine may be designed with rotor blades and blade tips specifically configured within a casing or housing sized to promote symmetrical heating and cooling while maintaining an optimum clearance gap during engine warm up and cool down while the aircraft is driven on the ground by the electric tax system during push back or taxi-in. Other engine components, including, for example, the rotor shaft, that are subject to thermal deformation when temperatures of these components fluctuate and are not maintained at a steady level during engine operation may also be designed to conform to tolerances that may be different from those required in engines that must warm up or cool down quickly. Other aspects of aircraft engine design that avoids uneven or asymmetrical thermal expansion or contraction of engine components when extended engine warm up and cool down periods are available are also contemplated to be within the present method. When an engine's operating envelope is changed, which is the case with the longer engine warm up and cool down time periods possible with the present method, corresponding changes in engine hardware and software may be required to ensure optimum efficiency of operation.

While the present invention has been described with respect to preferred embodiments, this is not intended to be limiting, and other arrangements, structures, and steps that perform the required functions are contemplated to be within the scope of the present invention.

### INDUSTRIAL APPLICABILITY

The present invention will find its primary applicability where it is desired to improve aircraft engine operating efficiency during flight without adversely impacting airport and airline ground operations when the additional time required to warm up and cool down aircraft engines to enhance engine operating efficiency is provided during ground operations while aircraft are driven between landing and take off by electric taxi systems.

1. A method for extending time available for aircraft engine cool down after landing and time available for aircraft engine warm up prior to take off without increasing time aircraft spend on the ground between landing and takeoff, comprising:
a. in an aircraft equipped with nose landing gear wheel-mounted pilot controlled electric taxi systems and engines requiring a cool down time and a warm up time, determining an engine cool down time period and an engine warm up time period sufficient to cool down and warm up the engines while preventing damage to engine components;
b. upon arrival and after the aircraft lands, reducing engine throttle settings, activating the electric taxi systems, and driving the aircraft on the ground with both the electric taxi systems and with the engine reduced throttle setting;
c. after the engine cool down time period, shutting off the aircraft engines, and driving the aircraft with only the electric taxi systems to a parking location and inactivating the electric taxi systems;
d. upon departure, activating the pilot electric taxi systems and driving the aircraft with the electric taxi systems out of the parking location to an engine warm up location, turning the aircraft engines on and driving the aircraft with the electric taxi systems and with the aircraft engines at a throttle setting below idle thrust for the engine warm up period from the engine warm up location to an engine thrust location; and
e. at the engine thrust location, inactivating the electric taxi systems, and increasing thrust of the warmed up engine to idle thrust or to takeoff thrust prior to takeoff.

2. The method of claim 1, further comprising locating the engine thrust location at a distance from the engine warm up location determined to correspond to the warm up time period so that when the aircraft is driven by the electric taxi systems and the aircraft engines at a throttle setting below idle thrust from the engine warm up location to the engine thrust location, the aircraft engines are warmed up.

3. The method of claim 1, further comprising after the aircraft lands, turning off the aircraft engines, driving the aircraft only with the electric taxi systems, and directing air from an aircraft source of cooling air on rotating components of the aircraft engines, causing rotation of the rotating components, and cooling the engines during the cooling down period while the aircraft is driven to the parking location by the electric taxi systems.

4. The method of claim 3, further comprising providing cooling air from an aircraft auxiliary power unit supply of bleed air and directing the cooling air on rotors of the aircraft engines.

5. The method of claim 1, further comprising determining a cool down time period and a warm up time period greater than 150 seconds.

6. A method for improving operating efficiency of aircraft engines in flight without increasing time an aircraft spends on the ground during push back, comprising:
a. equipping the aircraft with one or more pilot controlled electric taxi systems for autonomous ground movement, activating the electric taxi systems, and driving the aircraft with only the electric taxi systems in forward or reverse directions as required to leave an airport parking location;
b. driving the aircraft away from the airport parking location with the electric taxi systems to an aircraft engine warm up location between the airport parking location and an aircraft engine thrust location selected to provide a travel time between the aircraft engine warm up location and the aircraft engine thrust location corresponding to a warm up time required for the aircraft engines to warm up for take off as the electric taxi systems are driving the aircraft to the aircraft engine thrust location;
c. turning on the aircraft engines to an idle or a low throttle setting at the aircraft engine warm up location and driving the aircraft with the pilot controllable electric taxi systems while the aircraft engines are running at the idle or the low throttle setting from the aircraft engine warm up location to the aircraft engine thrust location; and
d. at the aircraft engine thrust location, inactivating the electric taxi systems and increasing aircraft engine thrust from the idle or low throttle setting to a thrust setting, and moving the aircraft only with the aircraft engine thrust from the aircraft engine thrust location to a runway takeoff location.

7. The method of claim 6, further comprising selecting an aircraft travel time between the engine warm up location and the engine thrust location that warms up the engines while controlling differential thermal expansion of engine components.

8. The method of claim 6, further comprising selecting the engine warm up location to require the engines to run for more than 150 seconds before the aircraft reaches the engine thrust location.

9. The method of claim 7, further comprising selecting the aircraft travel time to maintain a determined optimal clearance between engine rotor blade tips and an engine casing adjacent to the blade tips in the aircraft engines.

10. The method of claim 9, further comprising maintaining the determined optimal clearance between the engine rotor blade tips and the engine casing adjacent to the blade tips after take off and during flight.

11. The method of claim 6, further comprising determining the travel time between the engine warm up location and the engine thrust location based on selected designs of engines installed on the aircraft.

12. The method of claim 11, further comprising selecting an engine design requiring a warm up time exceeding 150 seconds.

13. The method of claim 6, further comprising providing aircraft engines designed to function efficiently only when the warm up time available permits the aircraft engines to warm up evenly and symmetrically as the electric taxi systems simultaneously drive the aircraft.

14. The method of claim 13, further comprising modifying components of the aircraft engines and software controlling engine operation to promote even and symmetrical warming of engine components and efficient engine function during a warm up time period.

15. A method for improving operating efficiency of aircraft engines in flight without increasing time an aircraft spends on the ground during taxi-in, comprising:
a. equipping an aircraft having at least a pair of aircraft engines with one or more pilot controlled electric taxi systems for autonomous ground movement and landing the aircraft at a touchdown location on an airport ground surface with the aircraft engines operating at an operating thrust setting;
b. activating the electric taxi systems, reducing the aircraft engine operating thrust to idle thrust or below, and driving the aircraft with the electric taxi systems while the aircraft engines are operating at the idle thrust or below the idle thrust for a time required to cool down the aircraft engines; and
c. when the aircraft engines are cooled down, shutting off the aircraft engines and driving the aircraft with only the electric taxi systems to an airport parking location.

16. The method of claim 15, further comprising reducing the thrust setting for each of the aircraft engines to a thrust setting determined to be ideal for even cooling of components of each of the engines.

17. The method of claim 15, further comprising providing aircraft engines designed to function efficiently only when the cool down time available permits the aircraft engines to cool down evenly and symmetrically as the electric taxi systems simultaneously drive the aircraft.

18. The method of claim 17, further comprising modifying components of the aircraft engines and software controlling engine operation to promote even and symmetrical cooling of engine components and efficient engine function during a cool down time period.
